(19) United States
(12) Patent Application Publication
(10) Pub. No.: US 2021/0256634 A1
(43) Pub. Date: Aug. 19, 2021

(54) ALLOCATION OF NATURAL RESOURCES

(71) Applicant: AquaShares Inc., Mill Valley, CA (US)

(72) Inventors: Matthew F. KENNEDY, San Francisco, CA (US); James G. WORKMAN, Mill Valley, CA (US)

(21) Appl. No.: 16/972,521

(22) PCT Filed: Jun. 5, 2019
(86) PCT No.: PCT/US2019/035661

§ 371 Date: Dec. 4, 2020

Related U.S. Application Data
(60) Provisional application No. 62/681,076, filed on Jun. 5, 2018.

(51) Int. Cl. G06Q 50/06; G06Q 10/06; G07C 13/00

(52) U.S. Cl. CPC G06Q 50/06; G07C 13/00; G06Q 10/06315

(57) ABSTRACT

A method of determining, for a user of a plurality of users, an entitlement of the user to a natural resource is disclosed. According to examples of the method, a first metric is determined, the first metric associated with a first one or more of: a usage of the natural resource by the user, a property right of the user relating to the natural resource, and an ability of the user to utilize the natural resource. A second metric is determined, the second metric associated with a second one or more of: a usage of the natural resource by M the user, a property right of the user relating to the natural resource, and an ability of the user to utilize the natural resource. A system allocation preference of the plurality of users is received. An entitlement value for the user is determined based on the determined first metric, the determined second metric, and the system allocation preference of the plurality of users.

### REFERENCE TO RELATED APPLICATION

This application claims priority to U.S. Provisional Patent Application No. 62/681,076, filed Jun. 5, 2018, the contents of which are incorporated herein in their entirety.

### FIELD OF THE INVENTION

The present invention relates generally to allocation of natural resources, and more specifically to allocation of common pool public natural resources, such as groundwater, among stakeholders of those natural resources.

### BACKGROUND OF THE INVENTION

Groundwater depletion is a relatively recent, widespread, and worsening global phenomenon. It afflicts tens of millions of people who depend on more than forty aquifers in the U.S. alone. Negative impacts include lowering of groundwater levels that dry out shallow wells, requiring expensive and deep wells, and escalate energy costs of pumping; reduced storage capacity creating risk for future users; seawater intrusion; degraded water quality; land subsidence interfering with surface land uses; and depletions of interconnected surface water impacting beneficial uses and users. Similar depletion and resulting impacts have come from open-access competition for other finite, renewable, public and common pool natural resources, such as clean air, wild marine fish, and terrestrial wildlife populations.

Groundwater depletion may be understood as having three related causes. First, the spread of affordable industrial drilling and pumping technology has lowered barriers to entry, enabling tens of millions of landowners to reach and extract vast amounts of formerly inaccessible resources such as water from deep below the surface to meet rising demand on the surface. Second, the innate self-interest of families, firms, and farmers who enjoy free access to a valued natural resource leads them individually and collectively to ‘race each other to the bottom’ until they exhaust or spoil the shared good on which all depend. Third, lacking any transparent and trust-building tools that can coordinate collective action, past governance efforts to prevent or address this “tragedy of the commons”—regulation, litigation and/or privatization—have proven painfully slow, expensive, contentious, and fraught with political risk.

In many cases, government entities avoid, delay or shirk the task of fairly allocating scarce common pool natural resources. Experience has taught them that the process (even raising it) of allocation can and does invariably provoke a fierce backlash, suspicion, and litigation from at least one and possibly most of their constituents. In the United States, California exemplifies the challenges associated with regulatory and legislative approaches. While California state law defines groundwater rights, it provides no clarity on the finite portion, share, percentile or amount of groundwater each individual claiming a groundwater right is entitled to access. Stakeholders in more than 20 groundwater basins have pursued court-managed, comprehensive adjudications to clarify their rights, but these processes have commonly taken millions of dollars and 5-10 years to resolve (up to 19 years in one case, including appeals) with the most contentious issue turning on allocation of pumping rights, an outcome that the court rulings by definition remove from local decision-making and consensus. Drawing on lessons from across the U.S., California passed the Sustainable Groundwater Management Act (SGMA) in 2014 with the intent of requiring hundreds of ‘high and medium priority’ basins to establish governing Groundwater Sustainability Agencies (GSAs) and develop Groundwater Sustainability Plans (GSPs) to achieve sustainability within 20 years. However, while local GSAs are empowered under SGMA to allocate groundwater use to well owners, the law does not authorize them to modify groundwater rights, nor does it prescribe any approach for establishing allocations in a fair and responsible manner. This lack of legislative clarity places GSA leaders managing basins that require curtailment of aggregate extractions in the unenviable position of having to decide how to do so. This example illustrates a common scenario that plagues authorities for groundwater allocations and governments worldwide for allocations of other natural resources, that are frequently caught up in costly, risky and slow outcomes, with no apparent reliable or equitable alternatives.

A solution is needed for allocating limited natural resources, such as groundwater, among the stakeholders who share those public resources. It is desirable that such a system and method leave stakeholders feeling confident that the process treats eligible users fairly; allow for outcomes that are compliant with local laws and regulations governing the distribution of natural resources; and achieve outcomes without the time and cost of drawn-out litigation and court managed processes.

### SUMMARY OF THE INVENTION

The presently disclosed examples are directed toward solving one or more of the problems presented in the prior art, as well as providing additional features that will become readily apparent by reference to the following detailed description when taken in conjunction with the accompanying drawings. In some examples, systems and methods are disclosed for allocating shares of a natural resource, such as groundwater, among stakeholders of that natural resource. A method of determining, for a user of a plurality of users, an entitlement of the user to a natural resource is disclosed. According to examples of the method, a first metric is determined, the first metric associated with a first one or more of: a usage of the natural resource by the user, a property right of the user relating to the natural resource, and an ability of the user to utilize the natural resource. A second metric is determined, the second metric associated with a second one or more of: a usage of the natural resource by the user, a property right of the user relating to the natural resource, and an ability of the user to utilize the natural resource. A system allocation preference of the plurality of users is received. An entitlement value for the user is determined based on the determined first metric, the determined second metric, and the system allocation preference of the plurality of users.

### BRIEF DESCRIPTION OF DRAWINGS

FIG. 1 illustrates an example distribution of a natural resource, such as groundwater, according to one or more examples of the disclosure.

FIG. 2 illustrates example metrics of distributing a natural resource, such as groundwater, among stakeholders of that natural resource, according to one or more examples of the disclosure.

FIG. 3 illustrates an example system for allocating shares of a natural resource among users of the system according to one or more examples of the disclosure.

FIGS. 4A-4B illustrate an example process for calculating share allocation values, according to one or more examples of the disclosure.

FIG. 5 illustrates an example process for calculating past usage-based entitlement values of a natural resource, according to one or more examples of the disclosure.

FIG. 6 illustrates an example process for calculating capacity-based entitlement values for a natural resource, according to one or more examples of the disclosure.

FIG. 7 illustrates an example process for calculating acreage-based entitlement values for a natural resource, according to one or more examples of the disclosure.

FIG. 8 illustrates an example process for calculating equity-based entitlement values for a natural resource, according to one or more examples of the disclosure.

FIGS. 9A-9F illustrate an example registration interface that could be presented to a stakeholder, according to one or more examples of the disclosure.

FIGS. 10A-10D illustrate an example share allocation interface that could be presented to a stakeholder, according to one or more examples of the disclosure.

FIG. 11 depicts an example computer system for implementing the systems and methods of the disclosure.

### DETAILED DESCRIPTION

Disclosed herein are devices, systems, methods, and computer-readable media for allocation of a natural resource among stakeholders in that natural resource. As used herein, three groups are involved in establishing allocations for a group of stakeholders: (i) a regulatory authority (“authority”) responsible for managing a natural resource (e.g. groundwater) and establishing allocations, (ii) a stakeholder advisory group (“advisor”) appointed by the authority and responsible for advising the authority regarding an approach to allocating the natural resource, and (iii) eligible users of the natural resource (“users”), which may be individuals or entities eligible to receive allocations for various uses (e.g. irrigating crops or selling their yearly allocation of groundwater pumping credits to others in a market). Users may include owners of real property (e.g., well owners) containing the natural resource; other private users of the natural resource (e.g. tenants leasing real property); public entities (e.g., states, cities, and municipalities, and/or their governments); organizations (e.g., corporations, regulatory authorities) with the power to allocate, assign, or distribute the natural resource including to other organizations (e.g., an authority); special interest groups (e.g. an environmental non-profit representing environmental interests, disadvantaged community advocates); market operators; or other individuals, groups, or entities with a right to extract, consume, distribute, or use the natural resource, or with an interest in doing so. Users may, but need not, be entities with existing legal rights to access a natural resource. Further, as used herein, users may include both actual users and potential users. Advisors may include representatives from any of the users described herein. In some examples, the natural resource may be groundwater; however, while groundwater may be used in several examples herein, the disclosure is not limited to allocation of groundwater, and examples of the disclosure may be applied to other natural resources as appropriate (e.g., surface water, oil, natural gas, or populations of fish, game, and wildlife).

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

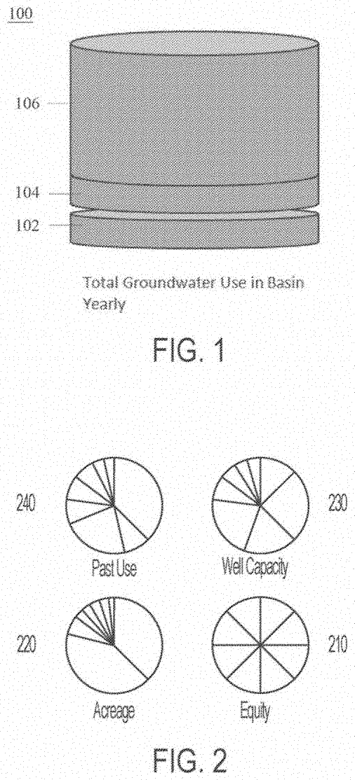

FIG. 1 shows an example high level distribution of a natural resource, such as groundwater. In the example of the figure, 100 represents a total quantity of the resource used in a year (e.g., from each unique groundwater basin). Of total quantity 100, a quantity 102 is used by entities exempt from authority constraints (e.g., a portion of groundwater exempted via legislative limits). A quantity 104 is set aside for one or more special interest groups identified by the authority (e.g. members of a disadvantaged community). The remainder, quantity 106, represents an amount of the natural resource for allocation among a target group of users. This disclosure is directed to systems and methods for allocating the quantity 106 among this target group of users by determining one or more entitlement values for each user, and then using these entitlement values and each user's preferences for them (e.g., votes) to establish a method (e.g., a formula) to calculate user-specific allocations of the natural resource. This approach differs from existing systems and methods that rely on authorities to make centralized decisions without fully educating all users about the impact of different viable approaches on them individually and without incorporating their preferences comprehensively into the final results.

In some cases, allocations are not mandated by laws or regulations. In California, for example, groundwater rights do not quantify usage values and the SGMA does not stipulate any one approach to establish pumping allocations. The systems and methods described herein can calculate or establish an entitlement value for each user (e.g., a well owner entitled to a share of groundwater) based on any single or combination of key physical resource-based metrics within the authority's region. An allocation for the user can then be determined, for example, based on the user's entitlement value(s), the entitlement values of other users, and preferences of each user. Entitlement values of several metrics, described below, may be used alone or in combination to calculate user allocation values; other metrics may be pertinent to local advisors and users.

FIG. 2 illustrates four example metrics by which an allocation of quantity 106 among a number of users can be determined for a groundwater application. Each of the metrics shown may carry certain advantages and disadvantages. Metric 210 depicts an equal distribution of a basin's groundwater use among land parcel owners. In some examples, reliably quantifying entitlement values of all users for metrics of interest (e.g. past use) may not be possible given lack of records (e.g., authority records). Use of metric 210 provides a simple, achievable method to allocate the resource. In some examples, smaller users may be excluded from the distribution; for example, in distribution of groundwater, users of less than a particular threshold of water (e.g., 2 acre-feet per year) may be excluded. This equal distribution approach may benefit smaller groundwater users relative to larger ones: carries the advantages of ensuring participation by all users who meet the requirements; and achieves an even distribution regardless of financial means, which may be viewed by local advisors and users as more equitable. However, a disadvantage of this approach is that it may result in inefficient distribution of resources (e.g., in that those who need the resource more are not entitled to more of it) and may be viewed by advisors and users as inequitable.

As an example of using this metric to establish an entitlement value and calculate an allocation, consider a hypothetical single farmer with three high capacity wells (out of a total 500 in the basin, each capable of extracting the same volume of water per minute). The farmer withdraws groundwater to irrigate 250 acres of berries, fruit trees and vegetables, and is one of 5,000 parcel owners in a city-suburban-rural complex. All landowners are spread out across 10,000 acres, covering the surface of an aquifer that over time been depleted by 30 percent. Under metric 210, the farmer's entitlement value would be 1.0 and his share allocation using metric 210 would be 1/5000 of the groundwater resource in the basin.

Metric 220 of FIG. 2 depicts a distribution of a basin's groundwater based on acreage owned (e.g., allocation of groundwater to a user is proportional to the acreage owned by that user within that authority's basin). An advantage of this metric is that it rewards overlying groundwater rights holders proportionately to their land ownership in the basin and provides allocations to land owners who may or may not have used the resource in the past (perhaps because of a philanthropic interest in conserving for the common good). Another advantage of this metric when applied by authorities in the United States is that such data is commonly available from county government agencies. One disadvantage is that it does not track actual usage of a resource or the land owner's ability to use the resource (e.g. a parcel sits atop granite through which groundwater wells cannot be drilled) and may consequently reward individuals or entities with no intention or ability to use the resource.

Following the example of the hypothetical farmer above, under metric 220, the farmer would have an entitlement value of 250 acres and receive a 250/10,000 share allocation of groundwater use in the basin.

Metric 230 of FIG. 2 depicts a distribution of a basin's groundwater use based on well capacity—the potential of a well to pump an amount of groundwater. Regardless of acreage or use, drilling logs often record the depth, diameter, yield and pumping force of a well. The drilling, enabling, maintenance and operation of each well represents a quantifiable expenditure of capital investment that can be applied toward share allocations as shown in metric 230. Advantages of this metric are that it promotes an economically efficient use of pumping resources and allocates based on users' abilities to access the resource. Two disadvantages are that these pumping resources may not track users' actual need for groundwater and may require each user to complete a well test at some cost. In the example of fisheries, “effort based” metrics may be used; these metrics consider engine capacity, days at sea, vessel size, gasoline burned, and “transferable effort shares.” These may be combined with or be valued regardless of actual catch histories.

In the example of fisheries, certain ‘catch share’ allocations are based on disproportionate payments tied either to a) vessel length and engine size or b) a governing authority (fee or auction). In groundwater this could equitably translate to an allocation formula in proportion to the parcel or property tax paid locally by all landowners, regardless of whether the landowner pumps groundwater.

Following the example of the hypothetical farmer above, under metric 230, the farmer would have an entitlement value of 3 wells and receive a 3/500 share allocation of groundwater use in the basin.

Metric 240 of FIG. 2 depicts a distribution of a basin's groundwater use based on past use of that groundwater; that is, users may be allocated an amount of groundwater use consistent with their past use of that groundwater, based on the assumption that the past use is predictive of the user's future need for groundwater. Past use also captures the history of capital expenditures invested into the resource; for example, larger deep, high-volume and energy-intensive pumps cost more to drill, build, operate and maintain than smaller ones. One example might include computing a user's average annual groundwater use over a recent 5-year period. In some territories, past use can represent the extent of a prescriptive groundwater right. In the example of marine fisheries, ‘catch share’ markets-based systems may use past harvest log records as the key metric in establishing entitlement values for fishermen.

Reliance on past use as a metric has the advantages of assigning more groundwater to those who are likely to use it the most, and minimizing the economic costs of shifting share ownership of the resource among users. But one potential drawback is that it excludes land owners with an overlying groundwater right who have not utilized that right. For example, landowners who have engaged in water conservation efforts in one year may be penalized by receiving a smaller allocation in future years.

One further disadvantage is the practical complication of determining past usage, since agencies often do not keep historical records of who extracted and used how much water at what time. In many groundwater basins, meters are infrequently used, and few well owners record or know how much water they have extracted from the earth in the past. Fearing punitive measures (rates, rations, restrictions, regulations), they are openly reluctant to accept or install meters that will reveal this information to governing authorities in the future. However, as described herein, past groundwater use can be estimated for a range of applications, including irrigation, municipal, industrial, commercial, or domestic use, even where water meters have not been in place. For example, the systems and methods described herein can access and repurpose data provided by third party services (e.g., California DWR's Land Use Viewer) that accurately estimate past land use (e.g., crop type, based on digital satellite imagery, aerial photography, ground truth surveys, and analytical tools), water use coefficients (e.g., acre-feet of water use per acre) by crop type (e.g., at county-level granularity or better), applied surface water deliveries (e.g. from California State Water Resource Control Board statement of water diversion and use), and applied groundwater (e.g., by calculation), all at field- or parcel-level granularity. Following the example of the hypothetical farmer above, these systems and methods can determine that the farmer with three wells irrigated his farm to the extent that he was responsible for pumping an average of 179 acre feet each year, which, in context represents a now clearly defined portion of groundwater use in the basin. This determined usage can be applied, via metric 240, to determine an amount of groundwater use to which the hypothetical farmer is entitled.

Various systems and methods for determining past and/or current applied or pumped groundwater usage can be employed depending on the user's application. For irrigation applications where meter data is not available, groundwater applied to crops can be calculated at the parcel level by first calculating total applied water (i.e., surface plus groundwater) and subtracting surface water deliveries. As mentioned above, third-party services are available to provide land use data (e.g., crop type) and applied water data by crop type measured in acre-feet per acre. Data can be provided more than a decade in the past, and in some cases three decades or more in the past (e.g., CA DWR Land Use Viewer), given availability of aerial photography and satellite imagery. Applied surface water by parcel can be identified from service water diversions, i.e., from SWRCB statements or irrigation district delivery records (in cases where an irrigation district owns surface water rights), then multiplied by estimates for distribution efficiency (e.g., 65% given delivery losses). Lastly, applied groundwater can be determined by dividing applied total water by estimates of on-farm efficiency (e.g., 75% given irrigation methodology or cultural practices like frost prevention) and subtracting surface water deliveries, at the parcel level.

For non-irrigation municipal or commercial applications where reliable, accurate water meter data is available, water meter data records can be used and validated by authority personnel. For example, municipal utilities may maintain and publish accurate records of metered groundwater pumping used to augment their supplies and commercial entities may be obligated to report groundwater pumped to state agencies (e.g., to CA DWR Division of Drinking Water).

For non-irrigation commercial applications where water meter data is not available, authority representatives may engage users on a case-by-case basis to estimate past groundwater use. For example, a commercial organization using groundwater to produce wine from grapes and other inputs may provide accounting of their bottle production records and industry standard metrics for water required per bottle produced; from these two metrics, an authority may estimate past groundwater use for this user.

For some residential applications, parcels in county records located outside of municipal or urban water utility boundaries may be assumed to rely on rural residential groundwater wells. Based on local monitoring of sample residential wells and/or urban water utility data, an authority may estimate per parcel residential use (e.g. 0.5 acre-feet per year) and total groundwater use within the authority's jurisdiction.

As noted, each of the example metrics described above (210, 220, 230, and 240) carries advantages and disadvantages, such that no single metric may represent an ideal solution for resource allocation. Advisors may recommend to an authority the use of one or more of these example metrics, and/or any other suitable metrics not expressly described here, as the basis for establishing an allocation formula. For each metric adopted by an Authority, entitlement values may be determined for each user and then used in any suitable combination to calculate resulting share allocation values for each user. Disclosed herein are systems and methods for first determining user entitlement values for each of a sample set of metrics, and then calculating share allocation values based on these user entitlement values and user preferences—for example, using a combination of metrics in a proportion voted on by eligible users.

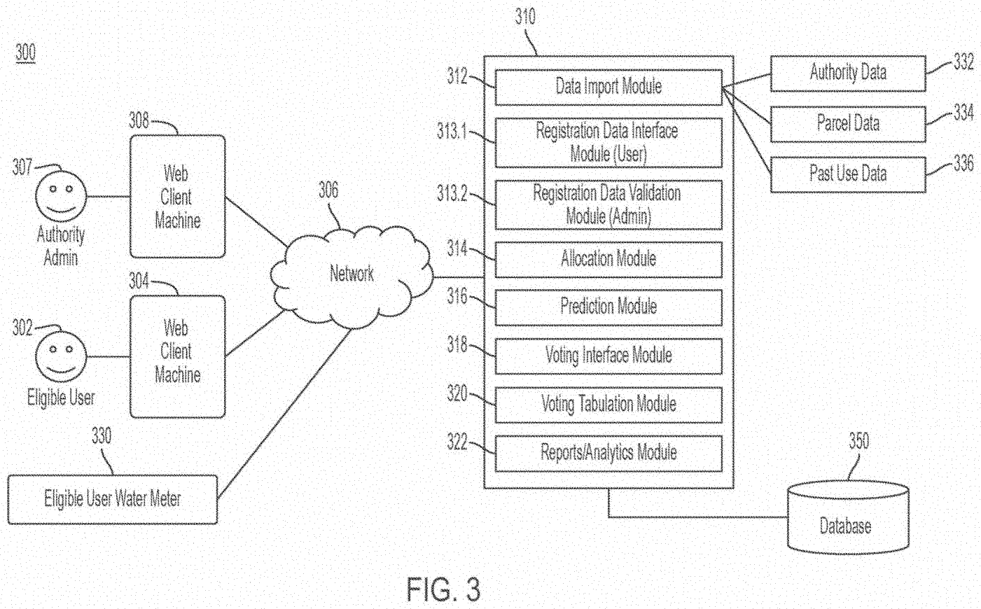

FIG. 3 shows an example computer system 300 for implementing the systems and methods disclosed herein. (In the examples herein, and in the accompanying figures, the name “AquaShares” is used to describe example computer system 300, and/or the operator of such a system.) In the example, a user 302 interfaces with a first web client machine 304, which communicates with a network 306. Additional web client machines may be connected to network 306; for example, as shown in the figure, a second web client machine 308 can connect to network 306 and may be used by an authority administrator. In the figure, processes 310 are processes that may be executed by one or more processors in communication with a memory, and in some examples, one or more databases 350. In some examples, the one or more processors may receive input from third party data sources 332, 334, and/or 336 (e.g., DWR's Land Use data set, authority administrative and resource GIS files). In some examples, the one or more processors may further receive input from one or more sensors, such as LIDAR, GPS, or environmental sensors; from remote sensing mechanisms, such as those for radio telemetry; from external sources, such as satellites; from third party data sources (e.g., NASA, USGS); or from any suitable combination of the above. A meter 330 for one or more market members can also provide input to the one or more processors.

With reference to FIG. 3, user 302 (e.g., a well owner) may be identified among all eligible users of the Natural Resource 106 (e.g., groundwater basin). In some examples, user 302 may be prompted to register with the AquaShares web platform and provide information for the purpose of calculating user-specific entitlement values for each selected allocation metric—e.g. past water use during a relevant, agreed upon (or selected) period (e.g. 2011-2015)—which in turn can be used together for the purpose of calculating a user-specific allocation of the natural resource.

In some examples, based on data provided by user 302 during registration on the platform, AquaShares can calculate and establish entitlement values for that user for each of the four metrics described above with respect to FIG. 2: past water use, well capacity, acreage owned, and equity. These entitlement values can be computed via one or more of processes 310, which may be considered to belong to one or more of various modules: for example, data import module 312; registration data interface module (User) 313.1; and registration data validation module (Admin) 313.2.

Processes of data import module 312 can receive data relevant to the determination of an entitlement value. For example, as described above with respect to the one or more processors of system 300, data import module 312 may receive input from third party sources, such as an authority data source 332 (e.g., geographic characteristics of the resource or authority administrative boundaries in GIS file form).

Data import module 312 also can use past use data 336 as input. Past use data 336 can include data collected through registration or, for irrigation applications, possibly a hydrological model that measures or estimates evapotranspiration, surface water applied, run-off, etc. (ese measurements or estimates can be provided through direct metering, satellite measurements, aerial photography, data analysis, etc.) Data import module 312 can further use as input parcel data 334 (e.g. from county parcel records) including geographic boundaries, acreage owned, APN, owner name, physical street address, and so on.

A Registration Data Interface Module 313.1 can import data provided by user 302 during registration, which may be used for calculating entitlement values (e.g. user-provided well capacity test results) or other administrative data (e.g., a user-provided demographic category, such as ‘Large Ag’ or ‘Municipal Utility,’ which may be useful for generating reports on the impact of any formula on each demographic category of users). A Registration Data Validation Module 313.2 can provide an assessment by the Authority Admin 307 of the accuracy of data provided by user 302 and validate it or request user-provided modifications. Together, modules 312, 313.1, and 313.2 can provide the data required for calculating user entitlement values, and database 350 can create appropriate associations among these data sets (e.g., associating user 302's land parcel APN with user 302's past use on that same parcel).

Based on the user 302 entitlement values calculated and established above, AquaShares can then calculate and establish share allocation values for that user via one more of the processes 310: for example, allocation module 314; prediction module 316; voting interface module 318; vote tabulation module 320; and reports/analytics module 322.

In some examples, user 302 can log into a personalized portal to review tentative share allocation values for each of the four allocation metrics, as calculated by allocation module 314 following completion of all registrations. User 302 can then vote for his or her preferred metric (e.g., past use; well capacity; acreage) via voting interface module 318. Vote results can be tabulated via vote tabulation module 320. With all votes or preferences recorded for all eligible users. AquaShares can present various allocation formulas computed using allocation module 314 to an Authority (e.g., GSA in California). AquaShares can further provide the authority with output from the reports/analytics module 322 to aid in selecting a single allocation formula that best achieves the authority's objectives. AquaShares can then distribute tentative allocations to users through the portal, in some examples offering user 302 an opportunity to appeal the calculations. Allocation percentages can then be finalized and distributed.

As one example, a share allocation formula that computes the proportion of a resource for allocation to a target group to which user 302 belongs (e.g., 106 described above with respect to FIG. 1) can be based on user preferences in the form of collected user votes, and can compute allocations equal to the sum of (1) the percentage of total votes for an equity metric (e.g., 210), times the allocation to user 302 under that equity metric; (2) the percentage of total votes for an acreage metric (e.g., 220), times the allocation to user 302 under that acreage metric; (3) the percentage of total votes for a well capacity metric (e.g., 230), times the allocation to user 302 under that well capacity metric; and (4) the percentage of total votes for a past use metric (e.g., 240), times the allocation to user 302 under that past use metric.

As another example, user share allocations may be computed based on user preferences, by establishing weightings for the four metrics that provide each user his/her highest possible allocation share value in percent, and normalizing to 100% in total across all users of the resource. Other approaches to compute share allocations could be proposed by advisors and approved by authorities based on user preferences.

As another example, share allocations may be computed based on predicted user preferences such as calculated by prediction module 316. A formula from predicted user preferences may take one of several forms. In one example, the authority may elect to predict each user's vote for a single allocation formula metric based on which metric offers each user the highest resulting share allocation value; this approach can minimize potential risk to the authority of unexpected user voting outcomes or the complexity of managing a voting process. In a second example, the authority may elect to predict all user entitlement values based on data available to the authority and predict resulting user votes for allocation formula metrics; this approach can minimize the complexity of comprehensively collecting all user data before establishing an allocation formula.

In some examples, a user 302 may be asked to consider granting allocation of shares to entities that do not hold groundwater rights. Some examples of such entities include local regulatory authorities (e.g., the GSA in California), such as to assist with managing the market (e.g. providing price stability), or to partially or fully fund operations to reduce regulatory fees imposed on landowners. Examples also include special interest groups, such as agencies representing disadvantaged communities entitled to allocated shares under various laws (e.g., Human Right to Water laws).

In some examples, the share allocations values (% of resource) distributed to user 302 can then be used to limit individual use and therefore aggregate use. As an example, assuming an aggregate limit of total groundwater use for a program is identified in acre-feet (AF), each individual user may be allowed to withdraw a volume of groundwater equal to a user share allocation (e.g., a percentage) times an aggregate volume limit (e.g., in acre-feet).

In some examples. Reports/Analytics module 322 can compile and distribute data and analytics relating to the allocation of resources; for example, with respect to individual user 302; to a demographic group of users; or to all Users.

For any program that leverages groundwater use allocations, the authority (e.g., in California, a GSA) may need to identify and leverage some technology to measure individual well owner extractions (e.g. satellite data to compute evapotranspiration, water meters) to compare against these allocations. The AquaShares platform can import data from such technologies, such as user water meter 330 in FIG. 3. This comparison may be required to ensure well owner compliance with the authority's program.

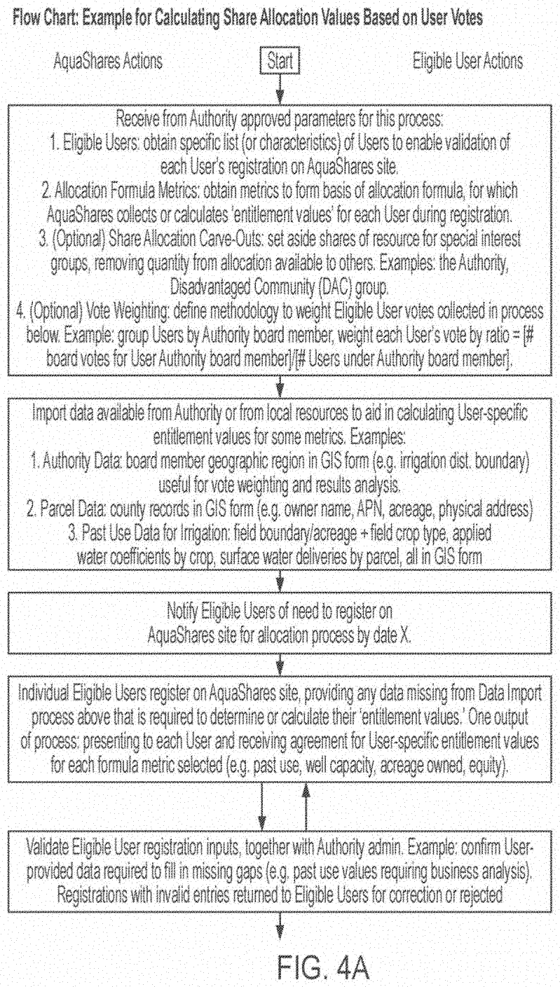

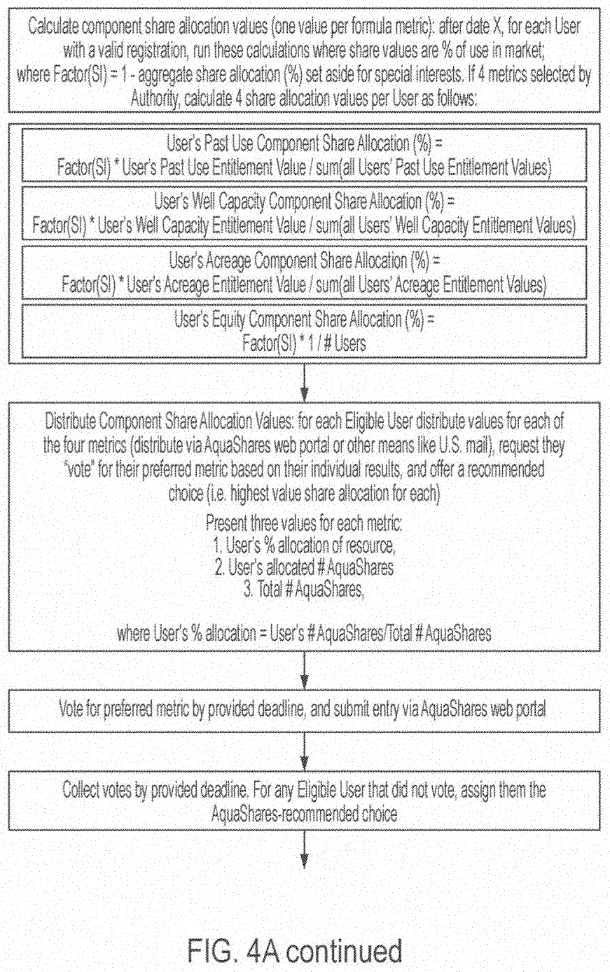

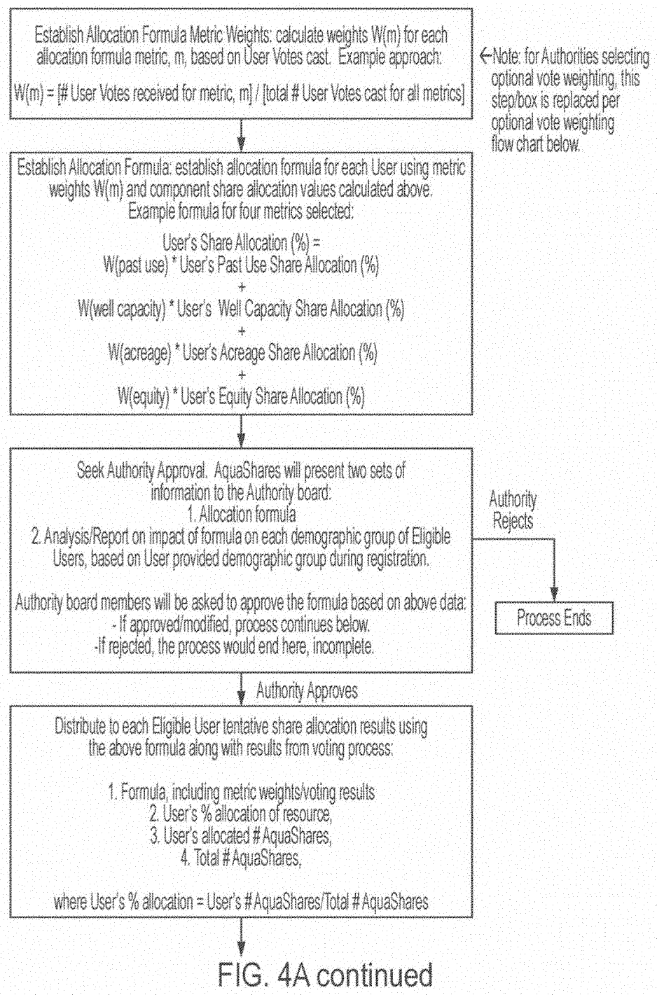

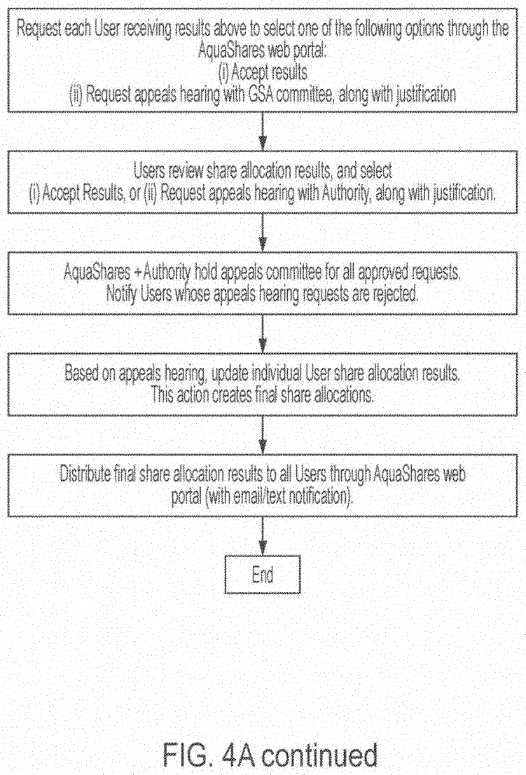

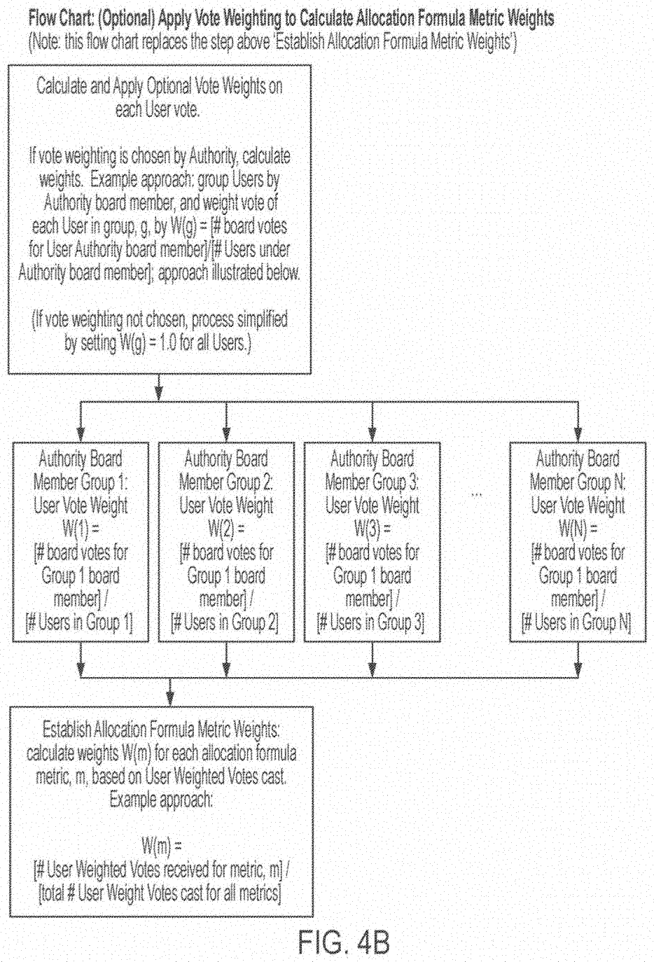

FIGS. 4A-4B illustrate an example process 400 for creating a single formula that can be used to calculate the share allocation value for each eligible user that may be executed by one or more processors of example system 300 described above. For example, example process 400 could be executed as part of one or more of data import module 312; registration data interface module 313.1; registration data validation module 313.2; allocation module 314; prediction module 316; voting interface module 318: vote tabulation module 320; and reports/analytics module 322. The text of FIGS. 4A and 4B is incorporated by reference herein in its entirety.

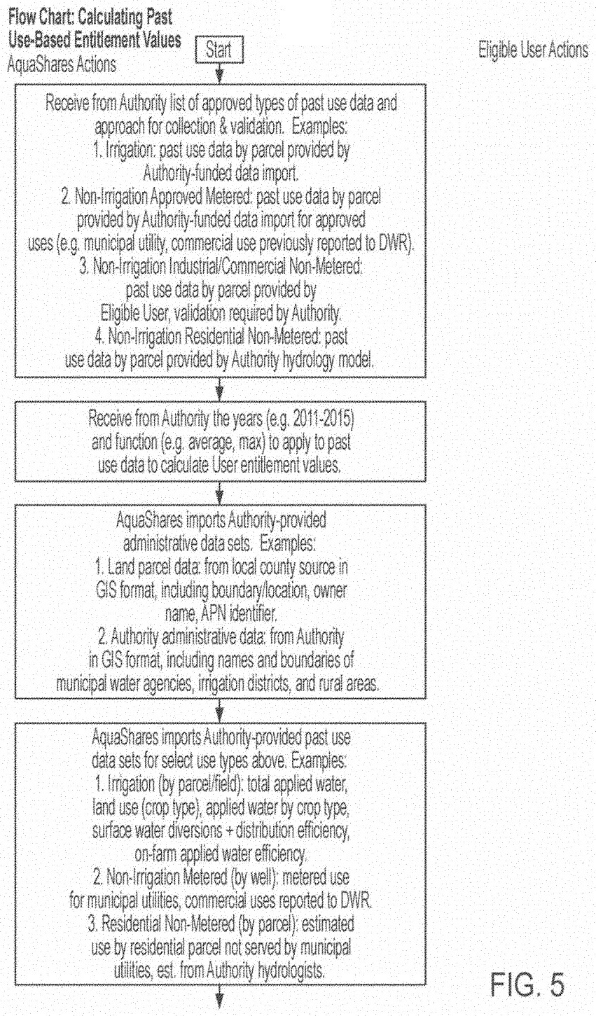

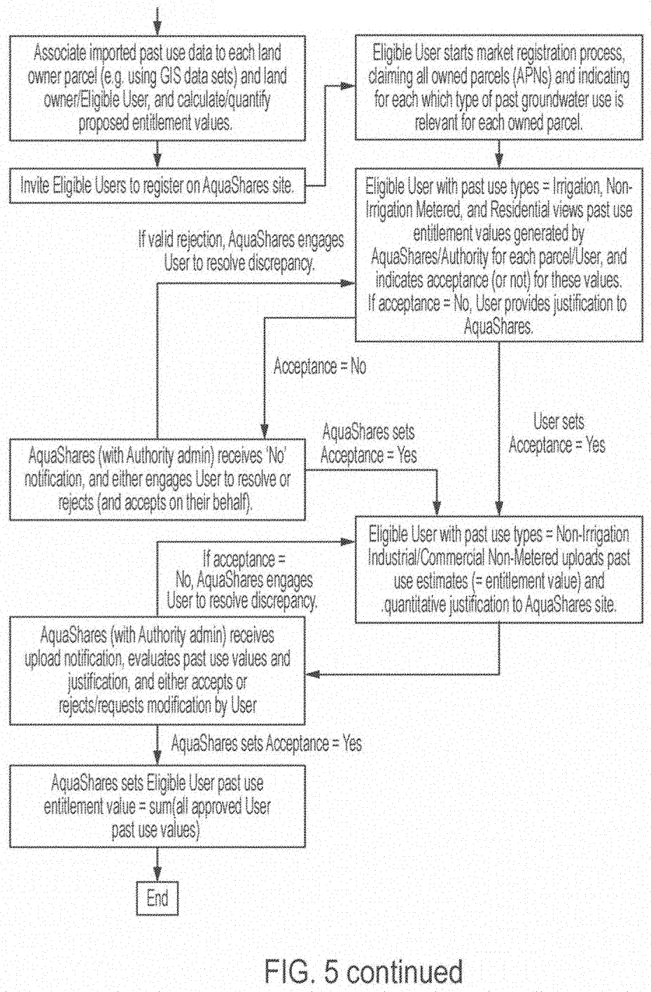

FIGS. 5A-5C illustrate an example process 500 for calculating past usage of a natural resource (e.g., groundwater) that may be executed by the one or more processors of example system 300 described above. For example, example process 500 could be executed as part of one or more of data import module 312; registration data interface module (User) 313.1; registration data validation module (Admin) 313.2; allocation module 314; prediction module 316; voting interface module 318; vote tabulation module 320; and reports/analytics module 322. The text of FIGS. 5A, 5B, and 5C is incorporated by reference herein in its entirety.

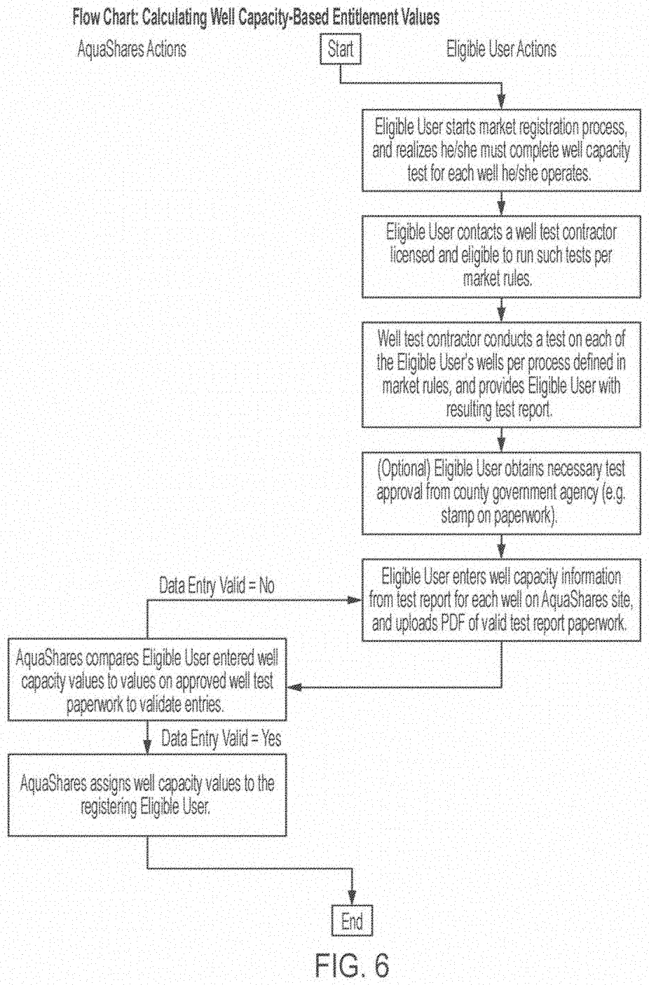

FIG. 6 illustrates an example process 600 for calculating capacity-based entitlement values for a natural resource (e.g., groundwater) that may be executed by the one or more processors of example system 300 described above. For example, example process 600 could be executed as part of one or more of data import module 312; registration data interface module 313.1: registration data validation module 313.2: allocation module 314; prediction module 316; voting interface module 318; vote tabulation module 320; and reports/analytics module 322. The text of FIG. 6 is incorporated by reference herein in its entirety.

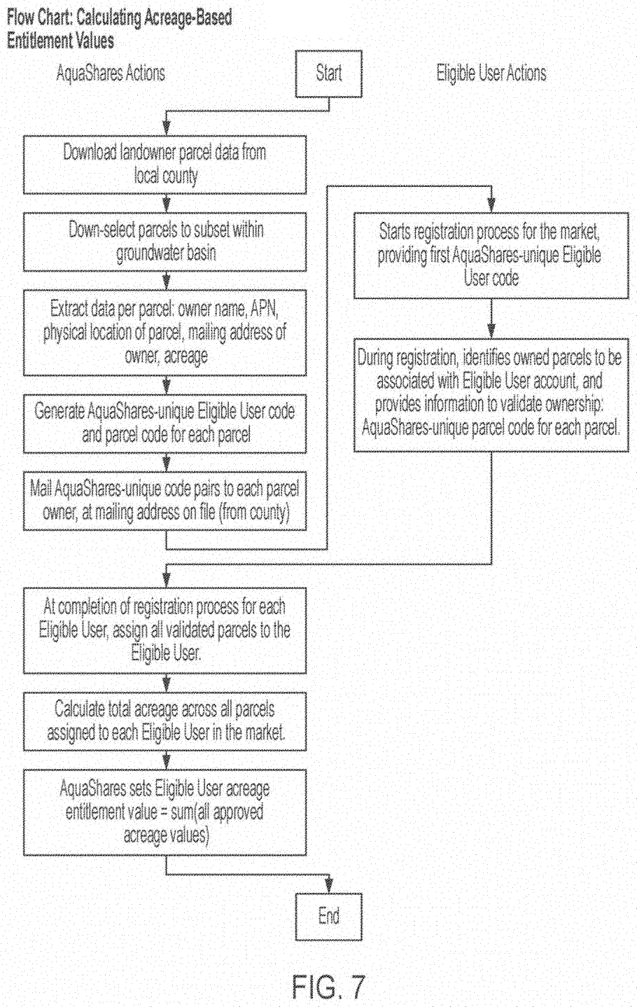

FIG. 7 illustrates an example process 700 for calculating acreage-based entitlement values for a natural resource (e.g., groundwater) that may be executed by the one or more processors of example system 300 described above. For example, example process 700 could be executed as part of one or more of data import module 312; registration data interface module 313.1: registration data validation module 313.2 allocation module 314; prediction module 316; voting interface module 318; vote tabulation module 320; and reports/analytics module 322. The text of FIG. 7 is incorporated by reference herein in its entirety.

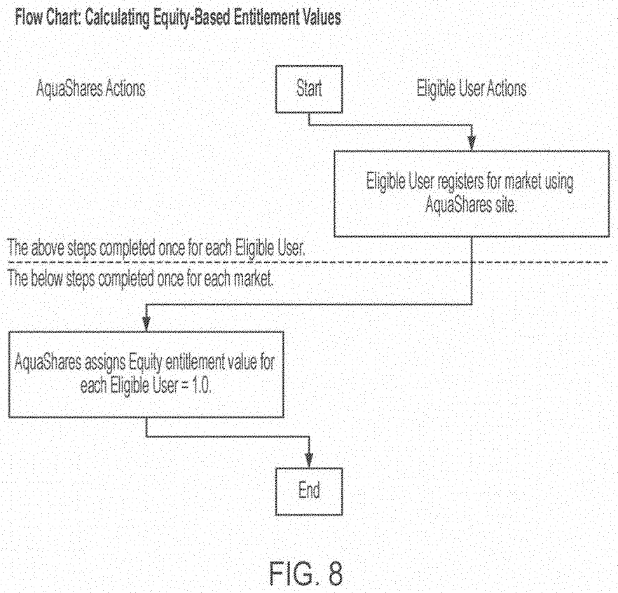

FIG. 8 illustrates an example process 800 for calculating equity-based entitlement values for a natural resource (e.g., groundwater) that may be executed by the one or more processors of example system 300 described above. For example, example process 800 could be executed as part of one or more of data import module 312; registration data interface module 313.1; registration data validation module 313.2; allocation module 314; prediction module 316; voting interface module 318; vote tabulation module 320: and reports/analytics module 322. The text of FIG. 8 is incorporated by reference herein in its entirety.

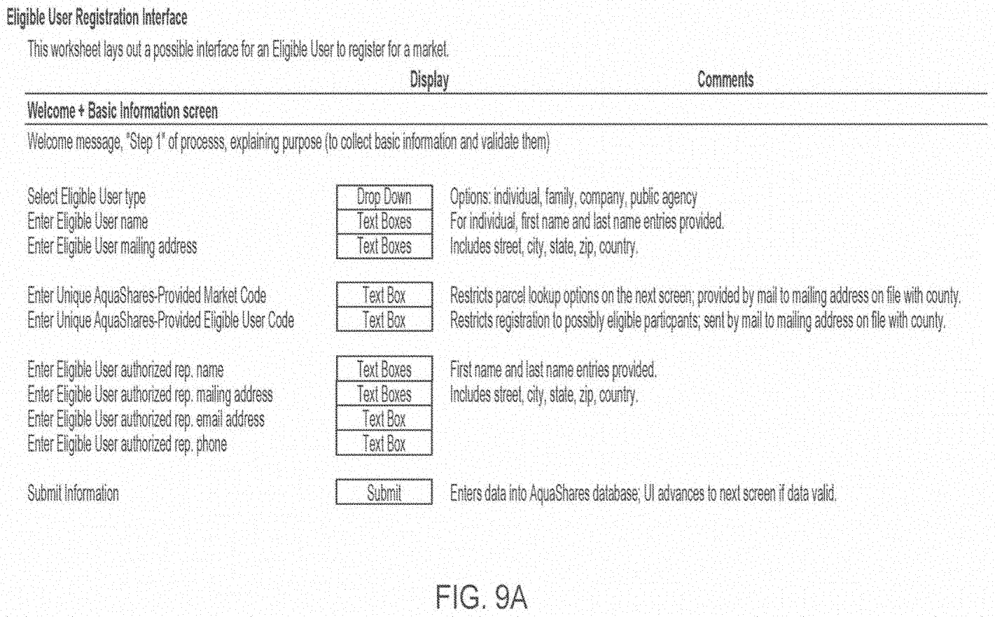

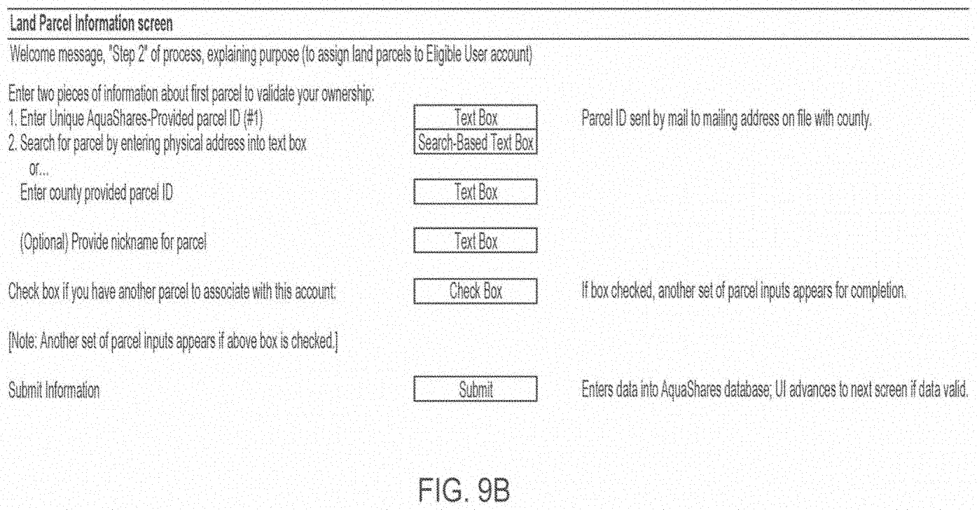

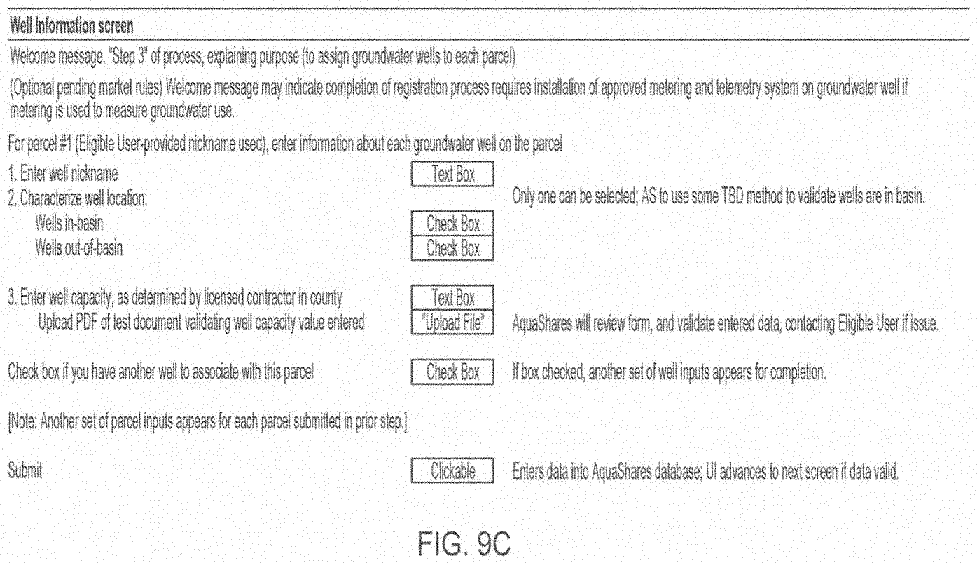

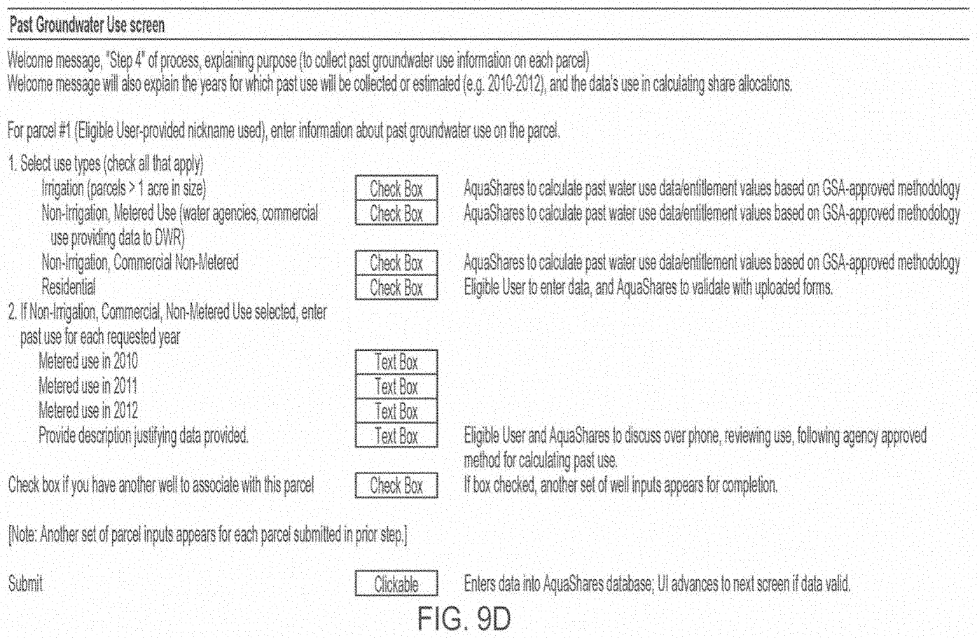

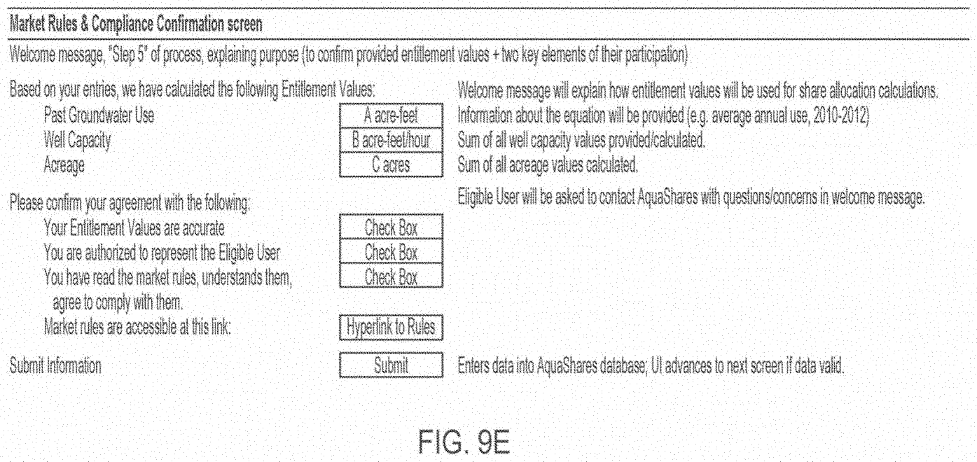

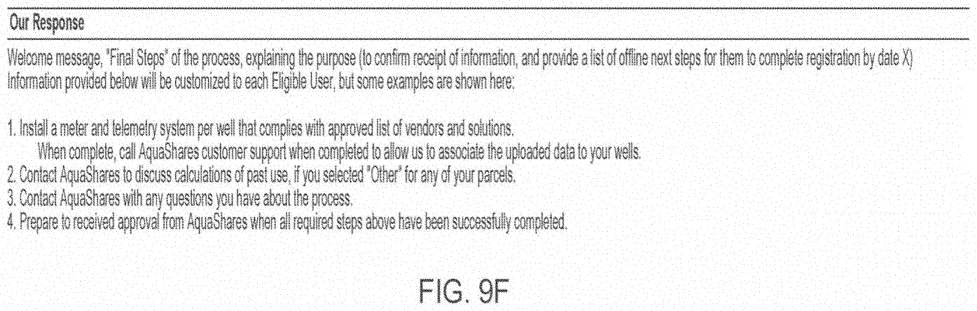

FIGS. 9A-9F illustrate an example registration interface 1100 that could be presented to an eligible user, such as user 302 described above, by example system 300. Example registration interface 1100 could be presented via one more web client machines, such as 304 in FIG. 3. The text of FIGS. 9A-9F is incorporated by reference herein in its entirety.

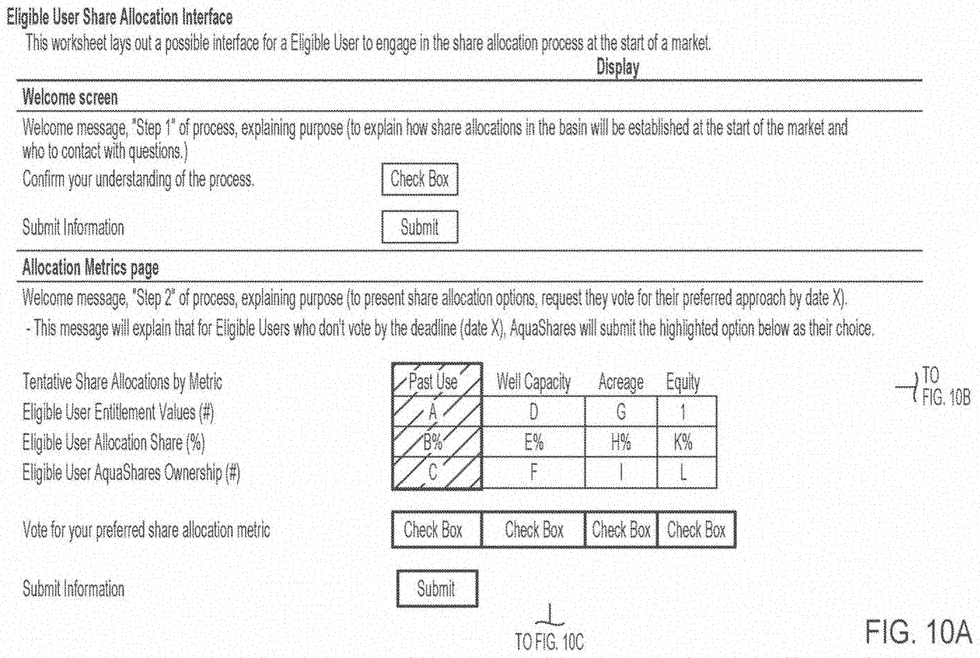

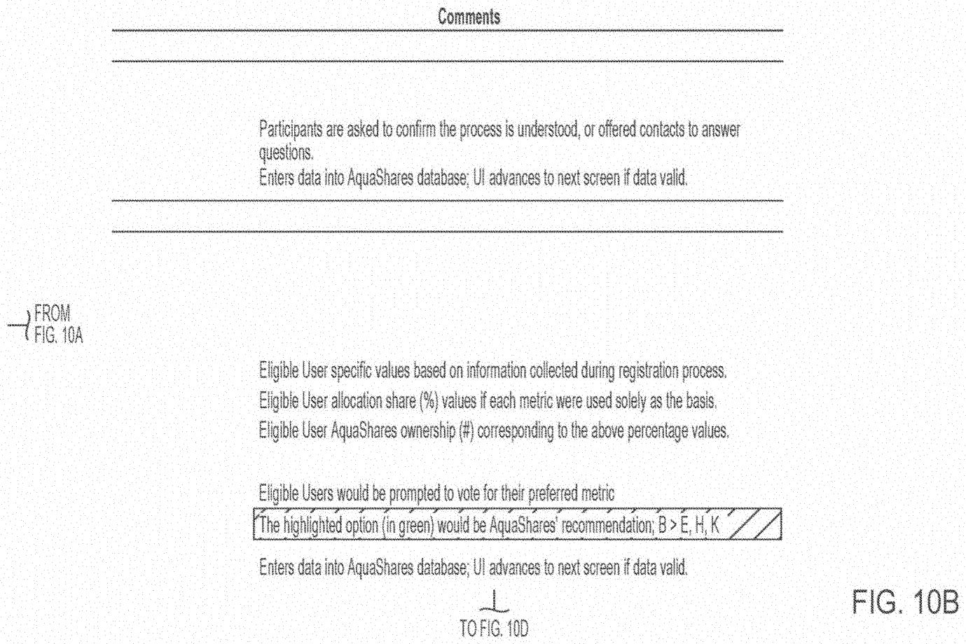

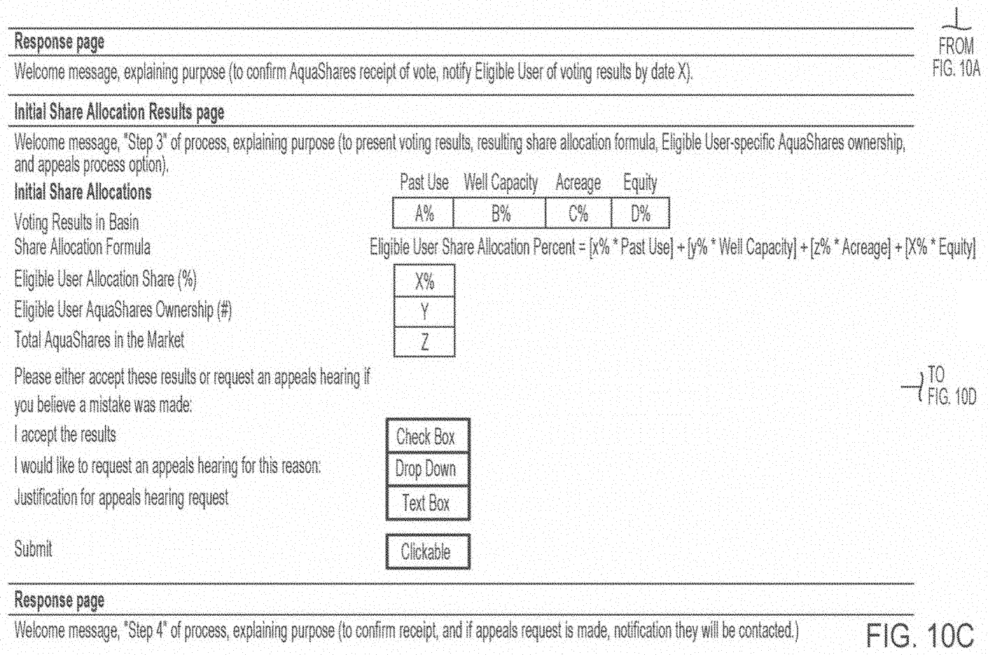

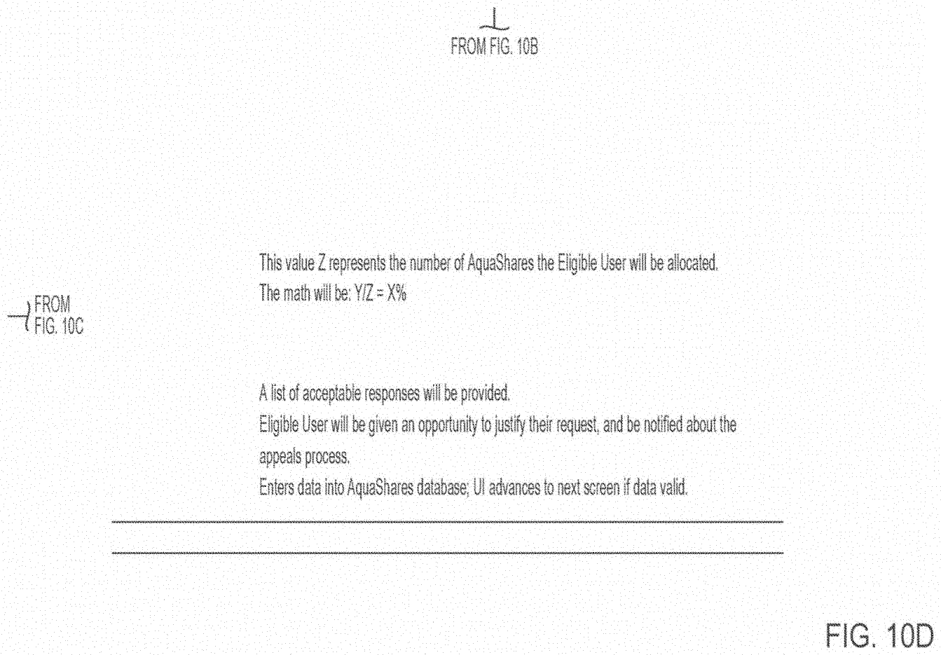

FIGS. 10A-10D illustrate an example share allocation interface 1200 that could be presented to an eligible user, such as user 302 described above, by example system 300. Example registration interface 1200 could be presented via one more web client machines, such as 304 in FIG. 3. The text of FIGS. 10A-10D is incorporated by reference herein in its entirety.

The examples described above may operate on one or more computers (e.g., one or more servers), including non-transitory computer readable recording media on a computer. This readable media contains the program instructions for accomplishing various steps described above. In the context of this disclosure, a computer-readable recording medium can be any medium that can contain or store programming for use by or in connection with an instruction execution system, apparatus, or device. Such computer readable media may be stored on a memory, where a memory is any device capable of storing a computer readable medium and capable of being accessed by a computer. A memory may include additional features. A computer may include a processor. A processor can be any device suitable to access a memory and execute a program stored thereon.

Communications may be transmitted between nodes over a communications network, such as the Internet. Other communications technology may include, but is not limited to, any combination of wired or wireless digital or analog communications channels, such as instant messaging (IM), short message service (SMS), multimedia messaging service (MMS) or a phone system (e.g., cellular, landline, or IP-based). These communications technologies can include Wi-Fi, BLUETOOTH, or other wireless radio technologies.

Examples of the disclosure may be implemented in any suitable form, including hardware, software, firmware, or any combination of these. Examples of the disclosure may optionally be implemented partly as computer software running on one or more data processors and/or digital signal processors. The elements and components of an example of the disclosure may be physically, functionally, and logically implemented in any suitable way. Indeed, the functionality may be implemented in a single unit, in multiple units, or as part of other functional units. As such, examples of the disclosure may be implemented in a single unit or may be physically and functionally distributed between different units and processors.

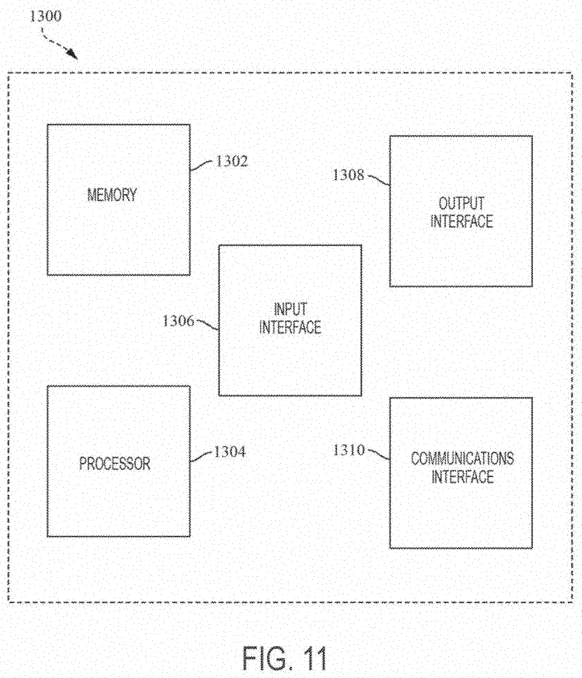

FIG. 11 illustrates an example computer 1300 capable of implementing the disclosed examples. Example computer 1300 includes a memory 1302, a processor 1304, an input interface 1306, an output interface 1308, and a communications interface 1310.

Memory 1302 may include volatile and non-volatile storage. For example, memory storage may include read only memory (ROM) in a hard disk device (HDD), random access memory (RAM), flash memory, and the like. The Operating System (OS) and application programs may be stored in ROM.

Specific software modules that implement embodiments of the described systems and methods may be incorporated in application programs on a server. The software may execute under control of an OS.

Processor 1304 may include any device suitable to access a memory and execute a program stored thereon.

Input interface 1306 may include a keyboard or mouse, for example. Output interface 1308 may include a conventional color monitor and printer, such as a conventional laser printer. Output interface 1308 may provide requisite circuitry to electrically connect and interface the display and printer to the computer system.

Communications interface 1310 may allow the network and nodes to connect directly, or over another network, to other nodes or networks. The network can include, for example, a local area network (LAN), a wide area network (WAN), or the Internet. In some examples, the network, modules, and nodes can be connected to another client, server, or device via a wireless interface.

In some examples, the input interface, processor, memory, communications interface, output interface, or combinations thereof, are interconnected by a bus.

The disclosed examples could be implemented via any suitable programming language or technology. Examples can run on a web server that provides a website for administrators to monitor the system results remotely. Anyone with administrative access to the web server can connect to and use visualization tools to take actions within a visualization. The examples can run on any type of server, including virtual servers or an actual machine.

The disclosed examples may be embodied on a distributed processing system to break processing apart into smaller jobs that can be executed by different processors in parallel. The results of the parallel processing could then be combined once completed.

Although the present invention has been fully described in connection with examples thereof with reference to the accompanying drawings, it is to be noted that various changes and modifications will become apparent to those skilled in the art. Such changes and modifications are to be understood as being included within the scope of the claimed subject matter. The various examples of the invention should be understood that they have been presented by way of example only, and not by way of limitation. Although the invention is described above in terms of various examples and implementations, it should be understood that the various features and functionality described in one or more of the individual examples are not limited in their applicability to the particular example with which they are described. They instead can, be applied, alone or in some combination, to one or more of the other examples of the invention, whether or not such examples are described, and whether or not such features are presented as being a part of a described example. Thus the breadth and scope of the claimed subject matter should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like; the term “example” is used to provide exemplary instances of the item in discussion, not an exhaustive or limiting list thereof; and adjectives such as “conventional,” “traditional.” “normal,” “standard,” “known,” and terms of similar meaning, should not be construed as limiting the item described to a given time period, or to an item available as of a given time. These terms should instead be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more.” “at least.” “but not limited to,” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs.

It will be appreciated that, for clarity purposes, the above description has described examples of the invention with reference to different functional units and modules. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the claimed subject matter. Further, in some examples, some steps in the processes disclosed herein may be forgone altogether while remaining within the scope of the claimed subject matter.

What is claimed is:

1. A method of determining, for a user of a plurality of users, an entitlement of the user to a natural resource, the method comprising:
determining a first metric associated with a first one or more of: a usage of the natural resource by the user, a property right of the user relating to the natural resource, and an ability of the user to utilize the natural resource;
determining, for the user, a second metric associated with a second one or more of: a usage of the natural resource by the user, a property right of the user relating to the natural resource, and an ability of the user to utilize the natural resource;
receiving a system allocation preference of the plurality of users; and
determining an entitlement value for the user based on the determined first metric, the determined second metric, and the system allocation preference of the plurality of users.

2. The method of claim 1, further comprising determining, for the user, a third metric associated with a third one or more of: a usage of the natural resource by the user, a property right of the user relating to the natural resource, and an ability of the user to utilize the natural resource, wherein the entitlement value for the user is further based on the determined third metric.

3. The method of claim 2, wherein:
the first metric comprises a metric associated with a prior usage of the natural resource by the user;
the second metric comprises a metric associated with an ownership of property associated with the natural resource; and
the third metric comprises a metric associated with an ability of the user to utilize the natural resource.

4. The method of claim 3, further comprising determining, for the user, a fourth metric associated with an even distribution of the natural resource among the plurality of users, wherein the entitlement value for the user is further based on the determined fourth metric.

5. The method of claim 1, further comprising allocating an amount of the natural resource to the user, the amount corresponding to the entitlement value.

6. The method of claim 1, wherein the natural resource comprises water, the first metric comprises a metric associated with the user's prior usage of the water, and determining the prior usage of the water by the user comprises determining the prior usage based on one or more of GPS data, sensor output, photographic data, a water use coefficient, a surface water delivery, and water metering data.

7. The method of claim 1, wherein the first metric comprises a metric associated with the ownership of property associated with the natural resource, and determining the first metric comprises receiving parcel data and determining an attribute of the property based on the parcel data.

8. The method of claim 1, wherein the natural resource comprises water, and determining the first metric comprises determining a water pumping capacity associated with the user.

9. The method of claim 1, wherein determining the system allocation preference comprises receiving a plurality of votes from the plurality of users, each vote of the plurality of votes corresponding to an allocation preference.

10. The method of claim 9, wherein receiving the plurality of votes comprises receiving the plurality of votes via an electronic portal.

11. The method of claim 9, wherein each vote corresponds to one of the first metric and the second metric.

12. The method of claim 11, further comprising:
determining a first percentage of votes corresponding to the first metric; and
determining a second percentage of votes corresponding to the second metric;
wherein the entitlement value is determined based on:
a product of the first percentage and the determined first metric; and
a product of the second percentage and the determined second metric.

13. The method of claim 1, wherein determining the system allocation preference comprises predicting a preference of the plurality of users.

14. The method of claim 1, wherein the first metric comprises an amount of owned acreage.

15. The method of claim 1, wherein the natural resource comprises water and the first metric comprises an amount of irrigated acreage.

16. The method of claim 1, wherein the natural resource comprises water and the first metric comprises a well capacity.
